(19) United States
(12) Patent Application Publication
(10) Pub. No.: US 2014/0044162 A1
(43) Pub. Date: Feb. 13, 2014

(54) ADAPTIVE INFERENCE MODE INFORMATION DERIVATION IN SCALABLE VIDEO CODING

(71) Applicant: QUALCOMM Incorporated, San Diego, CA (US)

(72) Inventors: Liwei GUO, San Diego, CA (US); Jianle CHEN, San Diego, CA (US); Chengjie TU, San Diego, CA (US); Marta KARCZEWICZ, San Diego, CA (US); Xiang LI, San Diego, CA (US); Vadim SEREGIN, San Diego, CA (US)

(73) Assignee: QUALCOMM Incorporated, San Diego, CA (US)

(21) Appl. No.: 13/959,635

(22) Filed: Aug. 5, 2013

Related U.S. Application Data
(60) Provisional application No. 61/681,109, filed on Aug. 8, 2012.
(60) Provisional application No. 61/707,475, filed on Sep. 28, 2012.
(60) Provisional application No. 61/749,865, filed on Jan. 7, 2013.
(60) Provisional application No. 61/751,809, filed on Jan. 11, 2013.

(51) Int. Cl. H04N 7/26

(52) U.S. Cl. CPC H04N 19/00151
USPC 375/240.02

(57) ABSTRACT

Systems and methods for determining information about an enhancement layer of digital video based on information included in a base layer of digital video are described. In one innovative aspect, an apparatus for coding digital video is provided. The apparatus includes a memory for storing a base layer of digital video information and an enhancement layer of digital video information. The apparatus determines a syntax element value for a portion of the enhancement layer based on a syntax element value for a corresponding portion of the base layer. Decoding devices and methods as well as corresponding encoding devices and methods are described.

### CROSS REFERENCE TO RELATED APPLICATIONS

This application claims a priority benefit from U.S. Provisional Patent Application No. 61/681,109, filed Aug. 8, 2012, from U.S. Provisional Patent Application No. 61/707,475, filed Sep. 28, 2012, from U.S. Provisional Patent Application No. 61/749,865, filed Jan. 7, 2013, and from U.S. Provisional Patent Application No. 61/751,809, filed Jan. 11, 2013, all four of which are incorporated by reference in their entireties.

### TECHNICAL FIELD

This disclosure relates to video coding and compression and, in particular, to scalable video coding (SVC).

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques perform spatial (intra-picture) prediction and/or temporal (inter-picture) prediction to reduce or remove redundancy inherent in video sequences. For block-based video coding, a video slice may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

Some block-based video coding and compression schemes make use of scalable techniques, such as scalable video coding (SVC). Generally described, scalable video coding refers to video coding in which a base layer and one or more scalable enhancement layers are used. For SVC, a base layer typically carries video data with a base level of quality. One or more enhancement layers carry additional video data to support higher spatial, temporal, and/or quality (also referred to as signal-to-noise ratio or SNR) levels. In some cases, the base layer may be transmitted in a manner that is more reliable than the transmission of enhancement layers.

Each of these layers may include one or more video blocks, which may be coded in a particular coding order (e.g., coded sequentially left-to-right and line-by-line, top-to-bottom). Layers may have the same block size or varying block sizes, depending on the spatial resolution of the layer.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include adaptively inferring information about a first layer of video data based on information included in a second layer of the video data.

In one embodiment, an apparatus for coding digital video is provided. The apparatus includes a memory configured to store a base layer of video information and an enhancement layer of video information. The base layer of video information comprises one or more base layer syntax element values for each of one or more portions of the base layer. The apparatus further includes a processor in communication with the memory. The processor is configured to determine an enhancement layer syntax element value for a portion of the enhancement layer based at least on a base layer syntax element value for a corresponding portion of the one or more portions of the base layer. The enhancement layer syntax element value determined by the processor corresponds to either a motion vector or a transform size.

In another embodiment, a method of decoding video is provided. The decoding method includes obtaining a video bitstream defining a base layer of video information and an enhancement layer of video information. The base layer of video information comprises one or more base layer syntax element values for each of one or more portions of the base layer. The method also includes determining an enhancement layer syntax element value for a portion of the enhancement layer based at least on a base layer syntax element value for a corresponding portion of the one or more portions of the base layer. The determined enhancement layer syntax element value corresponds to either a motion vector or a transform size.

In an additional embodiment, a method of encoding video is provided. The encoding method includes generating a video bitstream defining a base layer of video information and an enhancement layer of video information. The base layer of video information comprises one or more base layer syntax element values for each of one or more portions of the base layer. The encoding method also includes determining an enhancement layer syntax element value for a portion of the enhancement layer based at least on a base layer syntax element value for a corresponding portion of the one or more portions of the base layer. The determined enhancement layer syntax element value corresponds to either a motion vector or a transform size.

In a further embodiment, a computer readable storage medium comprising executable instructions is provided. The instructions cause an apparatus to obtain a base layer of video information and an enhancement layer of video information. The base layer of video information comprises one or more base layer syntax element values for each of one or more portions of the base layer. The instructions also cause an apparatus to determine an enhancement layer syntax element value for a portion of the enhancement layer based at least on a base layer syntax element value for a corresponding portion of the one or more portions of the base layer. The determined enhancement layer syntax element value corresponds to one of: a motion vector or a transform size.

In a still further embodiment, an apparatus for coding digital video is provided. The apparatus includes a means for obtaining a base layer of video information and an enhancement layer of video information. The base layer of video information comprises one or more base layer syntax element values for each of one or more portions of the base layer. The apparatus further includes a means for determining an enhancement layer syntax element value for a portion of the enhancement layer based at least on a base layer syntax element value for a corresponding portion of the one or more portions of the base layer. The determined enhancement layer syntax element value corresponds to one of: a motion vector or a transform size.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a block diagram of an illustrative video encoding and decoding system that may utilize the techniques of this disclosure.

FIG. 2 is a block diagram of an illustrative video encoder that may implement techniques of this disclosure.

FIG. 3 is a block diagram of an illustrative video decoder that may implement techniques of this disclosure.

FIG. 4 is a conceptual diagram showing illustrative video scalabilities in different dimensions.

FIG. 5 is a conceptual diagram showing an illustrative scalable video coded bitstream.

FIG. 6 is a conceptual diagram of illustrative access units in a scalable video coded bitstream.

FIG. 7 is a conceptual diagram showing an illustrative reconstructed portion of an image.

FIG. 8 is a conceptual diagram of to illustrative portions of video data.

FIG. 9 is a conceptual diagram of an illustrative coding unit.

FIG. 10 is a conceptual diagram of an illustrative portion of video data including layers encoded using inference mode.

FIG. 11 is a conceptual diagram of showing illustrative blocks of video data coded using residual prediction.

FIG. 12 is a flow diagram of an illustrative process for coding video data.

In the figures, to the extent possible, elements having the same or similar functions have the same designations.

### DETAILED DESCRIPTION

Generally described, the present disclosure relates to scalable video coding. In scalable video coding, video information may be logically or physically coded as multiple layers, such as a base layer and an enhancement layer. As described in greater detail below, any number of layers may be used, and each enhancement layer may build or improve upon its respective base layer. Portions (e.g., blocks, slices, etc.) of each enhancement layer and base layer may be defined by high-level syntax. For example, each portion may be defined at least partly by one or more syntax elements (e.g., motion vector, transform size, etc.). Each portion may have its own value for a particular syntax element, which may be the same or different than another portion's value for the same syntax element. In order to reduce the amount of data that is encoded and included in a video bitstream, values for certain syntax elements of an enhancement layer may be copied or inferred from the corresponding base layer. Therefore, the syntax elements to be copied for the enhancement layer do not need to be transmitted for the enhancement layer. Rather, the decoder can copy a syntax element value from a base layer for use with an enhancement layer. However, because enhancement layers and base layers may be encoded using different conditions (e.g., different resolutions, qualities, frequencies), copying a syntax element value from a base layer to an enhancement layer may not produce satisfactory results in some cases. For example, if an enhancement layer is encoded at a different resolution than its respective base layer, a motion vector for the base layer may not provide the desired results if copied for use in the enhancement layer. Such unsatisfactory results may be due to the difference in resolutions (e.g., the magnitude of the motion vector does not produce equivalent results in layers with a different display ratios or resolutions).

Aspects of this disclosure relate to adaptively inferring information regarding a base layer (e.g., syntax element values) to encode or decode an enhancement layer. When coding a block in an enhancement layer, the coder may identify a block in a base layer of the same frame from which to infer coding-related information (e.g., motion vectors, transform sizes). In some embodiments, the identified base layer block can be collocated with the enhancement layer block located at the same or substantially the same coordinates, or the identified base layer block may be offset from the location of the enhancement layer block. Rather than simply copying syntax element values from the corresponding base layer block, however, the syntax element values may be modified in order to adapt them from conditions under which the base layer was coded to the potentially different conditions under which the enhancement layer is coded.

For example, when a base layer is coded according to a first resolution, and the enhancement layer is coded according to a different (larger) resolution, a single block in the enhancement layer may correspond to a block of a different size in the base layer. Data from the base layer can be scaled to account for this difference in size (e.g., a motion vector from the base layer can be multiplied according to the ratio of the enhancement layer frame size to the base layer frame size in order to infer a motion vector for the enhancement layer). As another example, enhancement layer data may be calculated as a function of base layer data, such as a linear function (e.g., y=ax+b, where a and b are two parameters). When parameters are used in the linear function, they may be provided with the enhancement layer data, or the parameters may themselves be inferred or calculated from base layer data, other enhancement layer data, or some combination thereof. In some embodiments, modification parameters (e.g., parameters of a linear function, as described above and in greater detail below) may be determined based on an analysis of differences between the base layer and the enhancement layer. In some embodiments, the parameters may be based on experimentation to determine which values produce optimal or desired results.

Additional aspects of the disclosure relate to adaptively inferring information for an enhancement layer block from multiple base layer blocks, rather than a single base layer block. A single enhancement layer block may be collocated with or otherwise correspond to multiple base layer blocks. Coding-related information from the multiple base layer blocks can be merged to produce a single value, syntax element, or other data for the enhancement layer. For example, the information used for the enhancement layer may be the median or mean of the information from the base layer blocks. Other calculations and techniques may be used to “merge” information from multiple base layer blocks, in some cases depending upon the nature of the information. For example, if the information to be inferred is an intra-mode prediction direction, the merged direction may be calculated as that which has the minimum angular difference when compared to the intra-mode prediction directions of the multiple base layer blocks. As another example, if the information to be inferred is a motion vector, the merged motion may be calculated as the mean or median of the motion vectors from the multiple base layer blocks that correspond to the enhancement layer block.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

The techniques described in this disclosure generally relate to scalable video coding (SVC), though it will be recognized that these techniques may also be practiced with other techniques for video coding, examples of which are discussed above. For example, the techniques may be related to, and used with or within, a High Efficiency Video Coding (HEVC) scalable video coding (SVC) extension.

In an SVC extension, there may be multiple layers of video information. In some examples, an absolute base layer (i=0) and one or more scalable enhancement layers (i=1, 2, 3, etc.) may be provided. It will be recognized that an enhancement layer may serve as a base layer for higher enhancement layers. For example, an enhancement layer for which i=1 may serve as a base layer for an enhancement layer for which i=2, 3, 4, etc. Conversely, an enhancement layer may serve as an enhancement layer for any lower enhancement layer and the absolute base layer. For example, an enhancement layer for which i=2 may serve as an enhancement layer for the absolute base layer for which i=0 and for the enhancement layer for which i=1. In such an example, the enhancement layer for which i=1 may be considered to be a base layer for the enhancement layer for which i=2.

Scalable video coding (SVC) may be used to provide quality (also referred to as signal-to-noise (SNR)) scaling, spatial scaling and/or temporal scaling. An enhanced layer may have a different spatial resolution than that of the base layer. For example, the spatial aspect ratio between the enhancement layer and base layer can be 1.0, 1.5, 2.0, or any other ratios. In other words, the spatial aspect of the enhancement layer may equal 1.0, 1.5, or 2.0 times the spatial aspect of the base layer. In some examples, the scaling factor of the enhancement layer may be greater than the base layer. For example, the size of pictures in the enhancement layer may be greater than a size of pictures in the base layer. In this way, it may be possible, although not a limitation, that the spatial resolution of the enhancement layer is larger or otherwise different than the spatial resolution of the base layer.

For purposes of illustration only, the techniques described in the disclosure are described with examples including only two layers (e.g., a lower level layer such as a base layer and a higher level layer such as an enhancement layer). It should be understood that the examples described in this disclosure can be extended to examples with multiple base layers and/or enhancement layers as well.

As discussed above, each layer may include one or more blocks. Generally described, two blocks in different layers may be considered to be co-located if they occupy substantially corresponding spatial positions, but occur in different layers. For example, a base block in a base layer may be considered to be co-located with a non-causal block in the enhancement layer if the base block occupies a position in the base layer that is substantially similar to the position occupied by the non-causal block in the enhancement layer. It will be recognized that two co-located blocks may be the same size (for example, the base layer and the enhancement layer may have the same spatial resolution and/or partitioning mode), or may be different sizes (for example, the base layer and the enhancement layer may have different spatial resolutions or partitioning modes).

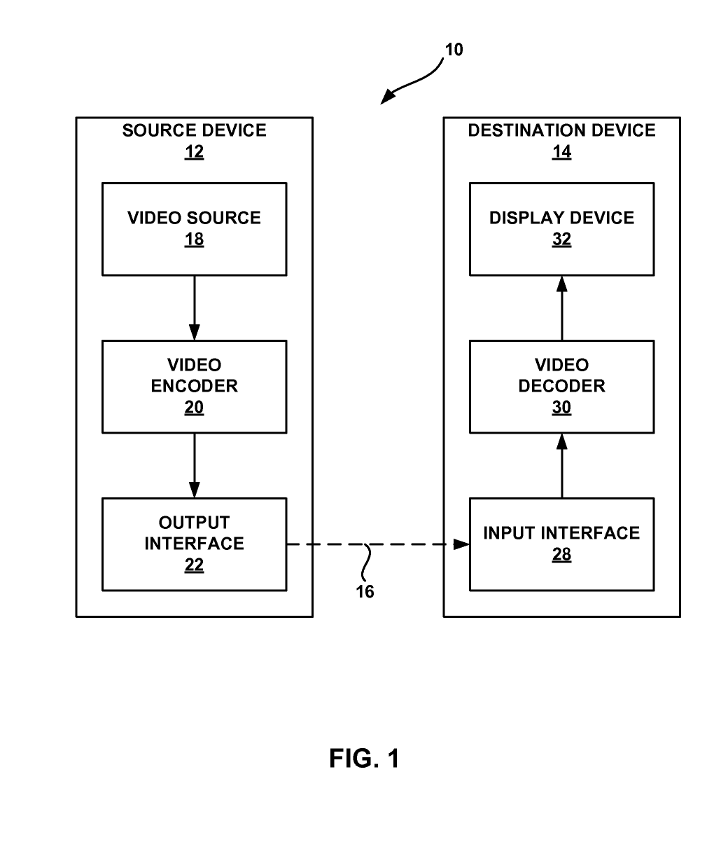

FIG. 1 is a block diagram that illustrates an example video coding system 10 that may utilize the techniques of this disclosure. As used described herein, the term “video coder” can refer to either or both video encoders and video decoders. In this disclosure, the terms “video coding” or “coding” may refer to video encoding and video decoding.

As shown in FIG. 1, video coding system 10 includes a source device 12 and a destination device 14. Source device 12 generates encoded video data. Accordingly, source device 12 may be referred to as a video encoding device. Destination device 14 may decode the encoded video data generated by source device 12. Accordingly, destination device 14 may be referred to as a video decoding device. Source device 12 and destination device 14 may be examples of video coding devices.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like. In some examples, source device 12 and destination device 14 may be equipped for wireless communication.

Destination device 14 may receive encoded video data from source device 12 via a channel 16. Channel 16 may comprise a type of medium or device capable of moving the encoded video data from source device 12 to destination device 14. In one example, channel 16 may comprise a communication medium that enables source device 12 to transmit encoded video data directly to destination device 14 in real-time. In this example, source device 12 may modulate the encoded video data according to a communication standard, such as a wireless communication protocol, and may transmit the modulated video data to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or other equipment that facilitates communication from source device 12 to destination device 14.

In another example, channel 16 may correspond to a storage medium that stores the encoded video data generated by source device 12. In this example, destination device 14 may access the storage medium via disk access or card access. The storage medium may include a variety of locally accessed data storage media such as Blu-ray discs, DVDs, CD-ROMs, flash memory, or other suitable digital storage media for storing encoded video data. In a further example, channel 16 may include a file server or another intermediate storage device that stores the encoded video generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives. Destination device 14 may access the encoded video data through a standard data connection, including an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1, source device 12 includes a video source 18, video encoder 20, and an output interface 22. In some cases, output interface 22 may include a modulator/demodulator (modem) and/or a transmitter. In source device 12, video source 18 may include a source such as a video capture device, e.g., a video camera, a video archive containing previously captured video data, a video feed interface to receive video data from a video content provider, and/or a computer graphics system for generating video data, or a combination of such sources.

Video encoder 20 may encode the captured, pre-captured, or computer-generated video data. The encoded video data may be transmitted directly to destination device 14 via output interface 22 of source device 12. The encoded video data may also be stored onto a storage medium or a file server for later access by destination device 14 for decoding and/or playback.

In the example of FIG. 1, destination device 14 includes an input interface 28, a video decoder 30, and a display device 32. In some cases, input interface 28 may include a receiver and/or a modem. Input interface 28 of destination device 14 receives encoded video data over channel 16. The encoded video data may include a variety of syntax elements generated by video encoder 20 that represent the video data. Such syntax elements may be included with the encoded video data transmitted on a communication medium, stored on a storage medium, or stored a file server.

Display device 32 may be integrated with or may be external to destination device 14. In some examples, destination device 14 may include an integrated display device and may also be configured to interface with an external display device. In other examples, destination device 14 may be a display device. In general, display device 32 displays the decoded video data to a user. Display device 32 may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to a HEVC Test Model (HM). The HEVC standard is being developed by the Joint Collaborative Team on Video Coding (JCT-VC) of ITU-T Video Coding Experts Group (VCEG) and ISO/IEC Motion Picture Experts Group (MPEG). A recent draft of the HEVC standard, referred to as “HEVC Working Draft 7” or “WD 7,” is described in document JCTVC-11003, Bross et al., “High efficiency video coding (HEVC) Text Specification Draft 7,” Joint Collaborative Team on Video Coding (JCT-VC) of ITU-T SG16 WP3 and ISO/IEC JTC1/SC29/WG11, 9th Meeting: Geneva, Switzerland, Apr. 27, 2012 to May 7, 2012, and the entire content of which is incorporated herein by reference.

Additionally or alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard or technique. Other examples of video compression standards and techniques include MPEG-2, ITU-T H.263 and proprietary or open source compression formats such as VP8 and related formats. In some examples, base layer and enhancement layers may be coded according to different coding standards.

Although not shown in the example of FIG. 1, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

FIG. 1 illustrates an example only. Techniques of this disclosure in video coding settings (e.g., video encoding or video decoding) may not include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

As mentioned, video encoder 20 encodes video data. The video data may comprise one or more pictures. Each of the pictures is a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture.

To generate the bitstream, video encoder 20 may perform encoding operations on each picture in the video data. When video encoder 20 performs encoding operations on the pictures, video encoder 20 may generate a series of coded pictures and associated data. The associated data may include sequence parameter sets, picture parameter sets, adaptation parameter sets, and other syntax structures. A sequence parameter set (SPS) may contain parameters applicable to zero or more sequences of pictures. A picture parameter set (PPS) may contain parameters applicable to zero or more pictures. An adaptation parameter set (APS) may contain parameters applicable to zero or more pictures. Parameters in an APS may be parameters that are more likely to change than parameters in a PPS.

To generate a coded picture, video encoder 20 may partition a picture into equally-sized video blocks. A video block may be a two-dimensional array of samples. Each of the video blocks is associated with a treeblock. In some instances, a treeblock may be referred to as a largest coding unit (LCU). The treeblocks of HEVC may be broadly analogous to the macroblocks of previous standards, such as H.264/AVC. However, a treeblock is not necessarily limited to a particular size and may include one or more coding units (CUs). Video encoder 20 may use quadtree partitioning to partition the video blocks of treeblocks into video blocks associated with CUs, hence the name “treeblocks.”

In some examples, video encoder 20 may partition a picture into a plurality of slices. Each of the slices may include an integer number of CUs. In some instances, a slice comprises an integer number of treeblocks. In other instances, a boundary of a slice may be within a treeblock.

As part of performing an encoding operation on a picture, video encoder 20 may perform encoding operations on each slice of the picture. When video encoder 20 performs an encoding operation on a slice, video encoder 20 may generate encoded data associated with the slice. The encoded data associated with the slice may be referred to as a “coded slice.”

To generate a coded slice, video encoder 20 may perform encoding operations on each treeblock in a slice. When video encoder 20 performs an encoding operation on a treeblock, video encoder 20 may generate a coded treeblock. The coded treeblock may comprise data representing an encoded version of the treeblock.

When video encoder 20 generates a coded slice, video encoder 20 may perform encoding operations on (i.e., encode) the treeblocks in the slice according to a raster scan order. In other words, video encoder 20 may encode the treeblocks of the slice in an order that proceeds from left to right across a topmost row of treeblocks in the slice, then proceeds from left to right across a next lower row of treeblocks, and so on until video encoder 20 has encoded each of the treeblocks in the slice.

As a result of encoding the treeblocks according to the raster scan order, the treeblocks above and to the left of a given treeblock may have been encoded, but treeblocks below and to the right of the given treeblock have not yet been encoded. Consequently, video encoder 20 may be able to access information generated by encoding treeblocks above and to the left of the given treeblock when encoding the given treeblock. However, video encoder 20 may be unable to access information generated by encoding treeblocks below and to the right of the given treeblock when encoding the given treeblock.

To generate a coded treeblock, video encoder 20 may recursively perform quadtree partitioning on the video block of the treeblock to divide the video block into progressively smaller video blocks. Each of the smaller video blocks may be associated with a different CU. For example, video encoder 20 may partition the video block of a treeblock into four equally-sized sub-blocks, partition one or more of the sub-blocks into four equally-sized sub-sub-blocks, and so on. A partitioned CU may be a CU whose video block is partitioned into video blocks associated with other CUs. A non-partitioned CU may be a CU whose video block is not partitioned into video blocks associated with other CUs.

One or more syntax elements in the bitstream may indicate a maximum number of times video encoder 20 may partition the video block of a treeblock. A video block of a CU may be square in shape. The size of the video block of a CU (i.e., the size of the CU) may range from 8×8 pixels up to the size of a video block of a treeblock (i.e., the size of the treeblock) with a maximum of 64×64 pixels or greater.

Video encoder 20 may perform encoding operations on (i.e., encode) each CU of a treeblock according to a z-scan order. In other words, video encoder 20 may encode a top-left CU, a top-right CU, a bottom-left CU, and then a bottom-right CU, in that order. When video encoder 20 performs an encoding operation on a partitioned CU, video encoder 20 may encode CUs associated with sub-blocks of the video block of the partitioned CU according to the z-scan order. In other words, video encoder 20 may encode a CU associated with a top-left sub-block, a CU associated with a top-right sub-block, a CU associated with a bottom-left sub-block, and then a CU associated with a bottom-right sub-block, in that order.

As a result of encoding the CUs of a treeblock according to a z-scan order, the CUs above, above-and-to-the-left, above-and-to-the-right, left, and below-and-to-the left of a given CU may have been encoded. CUs below and to the right of the given CU have not yet been encoded. Consequently, video encoder 20 may be able to access information generated by encoding some CUs that neighbor the given CU when encoding the given CU. However, video encoder 20 may be unable to access information generated by encoding other CUs that neighbor the given CU when encoding the given CU.

When video encoder 20 encodes a non-partitioned CU, video encoder 20 may generate one or more prediction units (PUs) for the CU. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

When video encoder 20 uses intra prediction to generate the predicted video block of a PU, video encoder 20 may generate the predicted video block of the PU based on decoded samples of the picture associated with the PU. If video encoder 20 uses intra prediction to generate predicted video blocks of the PUs of a CU, the CU is an intra-predicted CU. When video encoder 20 uses inter prediction to generate the predicted video block of the PU, video encoder 20 may generate the predicted video block of the PU based on decoded samples of one or more pictures other than the picture associated with the PU. If video encoder 20 uses inter prediction to generate predicted video blocks of the PUs of a CU, the CU is an inter-predicted CU.

Furthermore, when video encoder 20 uses inter prediction to generate a predicted video block for a PU, video encoder 20 may generate motion information for the PU. The motion information for a PU may indicate one or more reference blocks of the PU. Each reference block of the PU may be a video block within a reference picture. The reference picture may be a picture other than the picture associated with the PU. In some instances, a reference block of a PU may also be referred to as the “reference sample” of the PU. Video encoder 20 may generate the predicted video block for the PU based on the reference blocks of the PU.

After video encoder 20 generates predicted video blocks for one or more PUs of a CU, video encoder 20 may generate residual data for the CU based on the predicted video blocks for the PUs of the CU. The residual data for the CU may indicate differences between samples in the predicted video blocks for the PUs of the CU and the original video block of the CU.

Furthermore, as part of performing an encoding operation on a non-partitioned CU, video encoder 20 may perform recursive quadtree partitioning on the residual data of the CU to partition the residual data of the CU into one or more blocks of residual data (i.e., residual video blocks) associated with transform units (TUs) of the CU. Each TU of a CU may be associated with a different residual video block.

Video coder 20 may apply one or more transforms to residual video blocks associated with the TUs to generate transform coefficient blocks (i.e., blocks of transform coefficients) associated with the TUs. Conceptually, a transform coefficient block may be a two-dimensional (2D) matrix of transform coefficients.

After generating a transform coefficient block, video encoder 20 may perform a quantization process on the transform coefficient block. Quantization generally refers to a process in which transform coefficients are quantized to possibly reduce the amount of data used to represent the transform coefficients, providing further compression. The quantization process may reduce the bit depth associated with some or all of the transform coefficients. For example, an n-bit transform coefficient may be rounded down to an m-bit transform coefficient during quantization, where n is greater than m.

Video encoder 20 may associate each CU with a quantization parameter (QP) value. The QP value associated with a CU may determine how video encoder 20 quantizes transform coefficient blocks associated with the CU. Video encoder 20 may adjust the degree of quantization applied to the transform coefficient blocks associated with a CU by adjusting the QP value associated with the CU.

After video encoder 20 quantizes a transform coefficient block, video encoder 20 may generate sets of syntax elements that represent the transform coefficients in the quantized transform coefficient block. Video encoder 20 may apply entropy encoding operations, such as Context Adaptive Binary Arithmetic Coding (CABAC) operations, to some of these syntax elements. Other entropy coding techniques such as content adaptive variable length coding (CAVLC), probability interval partitioning entropy (PIPE) coding, or other binary arithmetic coding can also be used.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a sequence parameter set, a picture parameter set, a coded slice, supplemental enhancement information (SEI), an access unit delimiter, filler data, or another type of data. The data in a NAL unit may include various syntax structures.

Video decoder 30 may receive the bitstream generated by video encoder 20. The bitstream may include a coded representation of the video data encoded by video encoder 20. When video decoder 30 receives the bitstream, video decoder 30 may perform a parsing operation on the bitstream. When video decoder 30 performs the parsing operation, video decoder 30 may extract syntax elements from the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

After video decoder 30 extracts the syntax elements associated with a CU, video decoder 30 may generate predicted video blocks for the PUs of the CU based on the syntax elements. In addition, video decoder 30 may inverse quantize transform coefficient blocks associated with TUs of the CU. Video decoder 30 may perform inverse transforms on the transform coefficient blocks to reconstruct residual video blocks associated with the TUs of the CU. After generating the predicted video blocks and reconstructing the residual video blocks, video decoder 30 may reconstruct the video block of the CU based on the predicted video blocks and the residual video blocks. In this way, video decoder 30 may reconstruct the video blocks of CUs based on the syntax elements in the bitstream.

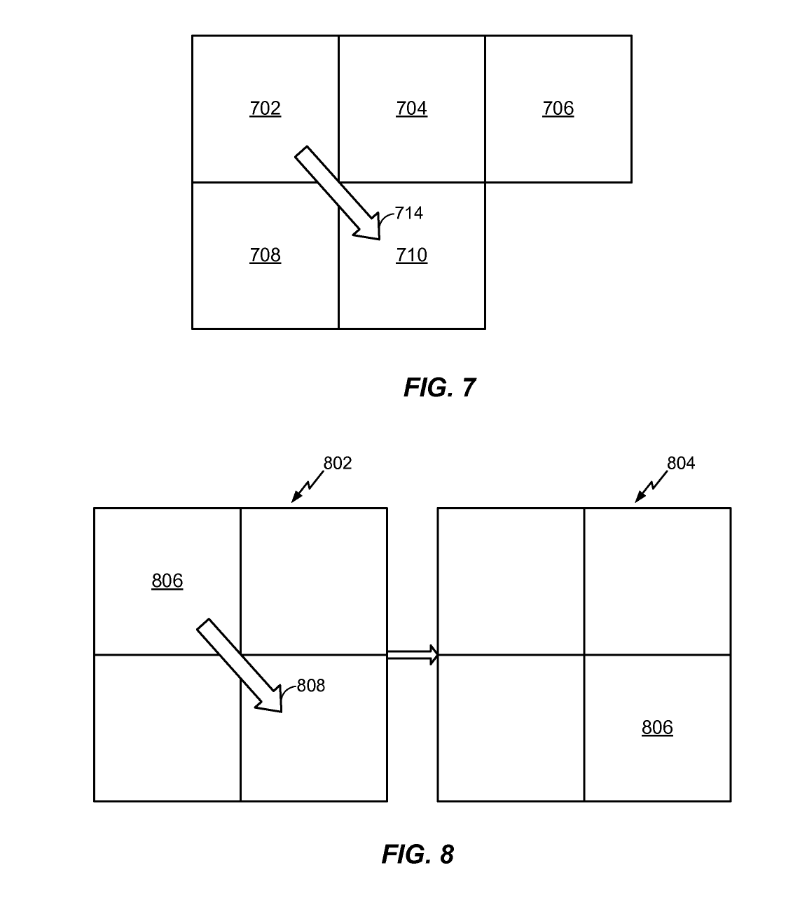

In accordance with embodiments of this disclosure, a video encoder 20 including a motion vector inference module 130 and/or a transform inference module 140 may be configured to code (e.g., encode) video data in a scalable video coding scheme that defines at least one base layer and at least one enhancement layer. The motion vector inference module 130 and transform inference module 140 may infer at least some syntax element values as part of an encoding process. For example, a motion vector and/or a transform size for a portion (e.g., a coding unit) of an enhancement layer may be adaptively inferred from the motion vectors and/or transform size in a corresponding portion of the base layer. Adaptive inference is described in greater detail below with respect to FIGS. 7-12.

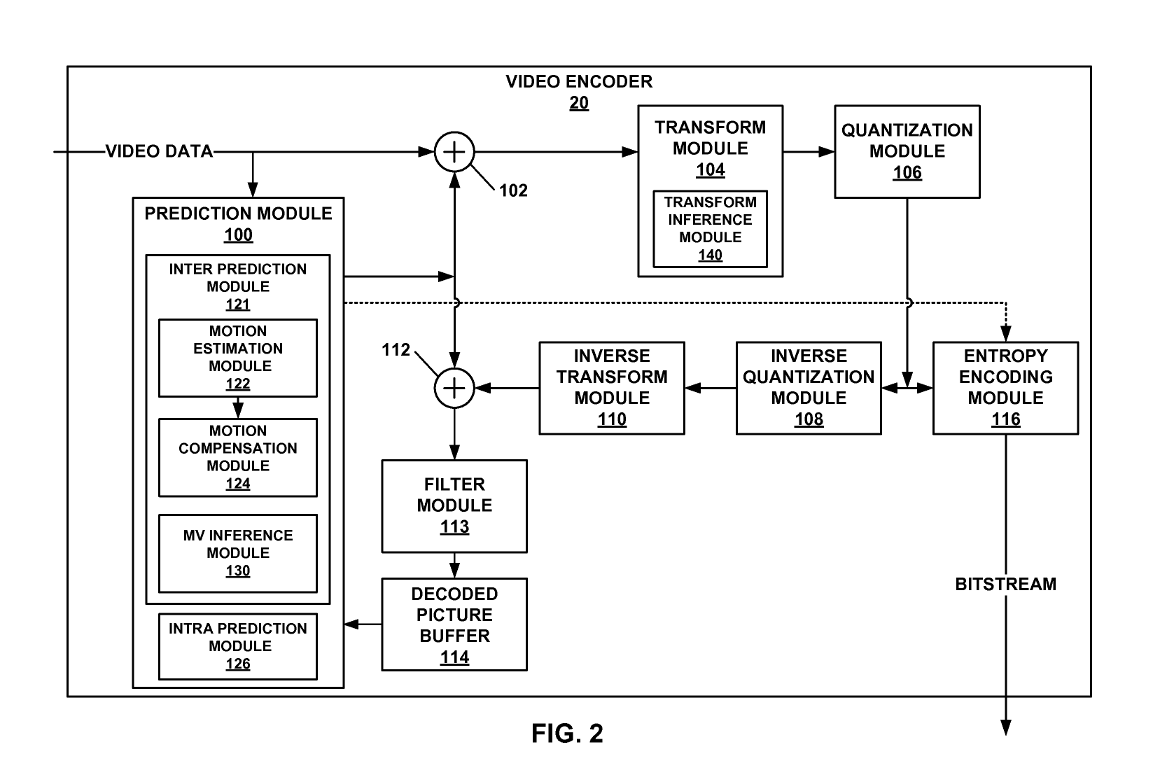

FIG. 2 is a block diagram that illustrates an example video encoder 20 that can be configured to implement the techniques of this disclosure. FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

In the example of FIG. 2, video encoder 20 includes a plurality of functional components. The functional components of video encoder 20 include a prediction module 100, a residual generation module 102, a transform module 104, a quantization module 106, an inverse quantization module 108, an inverse transform module 110, a reconstruction module 112, a filter module 113, a decoded picture buffer 114, and an entropy encoding module 116. Prediction module 100 includes an inter prediction module 121, motion estimation module 122, a motion compensation module 124, and an intra prediction module 126. In other examples, video encoder 20 may include more, fewer, or different functional components. Furthermore, motion estimation module 122 and motion compensation module 124 may be highly integrated, but are represented in the example of FIG. 2 separately for purposes of explanation.

Video encoder 20 may receive video data. Video encoder 20 may receive the video data from various sources. For example, video encoder 20 may receive the video data from video source 18 (FIG. 1) or another source. The video data may represent a series of pictures. To encode the video data, video encoder 20 may perform an encoding operation on each of the pictures. As part of performing the encoding operation on a picture, video encoder 20 may perform encoding operations on each slice of the picture. As part of performing an encoding operation on a slice, video encoder 20 may perform encoding operations on treeblocks in the slice.

As part of performing an encoding operation on a treeblock, prediction module 100 may perform quadtree partitioning on the video block of the treeblock to divide the video block into progressively smaller video blocks. Each of the smaller video blocks may be associated with a different CU. For example, prediction module 100 may partition a video block of a treeblock into four equally-sized sub-blocks, partition one or more of the sub-blocks into four equally-sized sub-sub-blocks, and so on.

The sizes of the video blocks associated with CUs may range from 8×8 samples up to the size of the treeblock with a maximum of 64×64 samples or greater. In this disclosure, “N×N” and “N by N” may be used interchangeably to refer to the sample dimensions of a video block in terms of vertical and horizontal dimensions, e.g., 16×16 samples or 16 by 16 samples. In general, a 16x16 video block has sixteen samples in a vertical direction (y=16) and sixteen samples in a horizontal direction (x=16). Likewise, an N×N block generally has N samples in a vertical direction and N samples in a horizontal direction, where N represents a nonnegative integer value.

Furthermore, as part of performing the encoding operation on a treeblock, prediction module 100 may generate a hierarchical quadtree data structure for the treeblock. For example, a treeblock may correspond to a root node of the quadtree data structure. If prediction module 100 partitions the video block of the treeblock into four sub-blocks, the root node has four child nodes in the quadtree data structure. Each of the child nodes corresponds to a CU associated with one of the sub-blocks. If prediction module 100 partitions one of the sub-blocks into four sub-sub-blocks, the node corresponding to the CU associated with the sub-block may have four child nodes, each of which corresponds to a CU associated with one of the sub-sub-blocks.

Each node of the quadtree data structure may contain syntax data (e.g., syntax elements) for the corresponding treeblock or CU. For example, a node in the quadtree may include a split flag that indicates whether the video block of the CU corresponding to the node is partitioned (i.e., split) into four sub-blocks. Syntax elements for a CU may be defined recursively, and may depend on whether the video block of the CU is split into sub-blocks. A CU whose video block is not partitioned may correspond to a leaf node in the quadtree data structure. A coded treeblock may include data based on the quadtree data structure for a corresponding treeblock.

Video encoder 20 may perform encoding operations on each non-partitioned CU of a treeblock. When video encoder 20 performs an encoding operation on a non-partitioned CU, video encoder 20 generates data representing an encoded representation of the non-partitioned CU.

As part of performing an encoding operation on a CU, prediction module 100 may partition the video block of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, prediction module 100 may perform geometric partitioning to partition the video block of a CU among PUs of the CU along a boundary that does not meet the sides of the video block of the CU at right angles.

Inter prediction module 121 may perform inter prediction on each PU of the CU. Inter prediction may provide temporal compression. To perform inter prediction on a PU, motion estimation module 122 may generate motion information for the PU. Motion compensation module 124 may generate a predicted video block for the PU based the motion information and decoded samples of pictures other than the picture associated with the CU (i.e., reference pictures). In this disclosure, a predicted video block generated by motion compensation module 124 may be referred to as an inter-predicted video block.

Slices may be I slices, P slices, or B slices. Motion estimation module 122 and motion compensation module 124 may perform different operations for a PU of a CU depending on whether the PU is in an I slice, a P slice, or a B slice. In an I slice, all PUs are intra predicted. Hence, if the PU is in an I slice, motion estimation module 122 and motion compensation module 124 do not perform inter prediction on the PU.

If the PU is in a P slice, the picture containing the PU is associated with a list of reference pictures referred to as “list 0.” Each of the reference pictures in list 0 contains samples that may be used for inter prediction of other pictures. When motion estimation module 122 performs the motion estimation operation with regard to a PU in a P slice, motion estimation module 122 may search the reference pictures in list 0 for a reference block for the PU. The reference block of the PU may be a set of samples, e.g., a block of samples, that most closely corresponds to the samples in the video block of the PU. Motion estimation module 122 may use a variety of metrics to determine how closely a set of samples in a reference picture corresponds to the samples in the video block of a PU. For example, motion estimation module 122 may determine how closely a set of samples in a reference picture corresponds to the samples in the video block of a PU by sum of absolute difference (SAD), sum of square difference (SSD), or other difference metrics.

After identifying a reference block of a PU in a P slice, motion estimation module 122 may generate a reference index that indicates the reference picture in list 0 containing the reference block and a motion vector that indicates a spatial displacement between the PU and the reference block. In various examples, motion estimation module 122 may generate motion vectors to varying degrees of precision. For example, motion estimation module 122 may generate motion vectors at one-quarter sample precision, one-eighth sample precision, or other fractional sample precision. In the case of fractional sample precision, reference block values may be interpolated from integer-position sample values in the reference picture. Motion estimation module 122 may output the reference index and the motion vector as the motion information of the PU. Motion compensation module 124 may generate a predicted video block of the PU based on the reference block identified by the motion information of the PU.

If the PU is in a B slice, the picture containing the PU may be associated with two lists of reference pictures, referred to as “list 0” and “list 1.” In some examples, a picture containing a B slice may be associated with a list combination that is a combination of list 0 and list 1.

Furthermore, if the PU is in a B slice, motion estimation module 122 may perform uni-directional prediction or bi-directional prediction for the PU. When motion estimation module 122 performs uni-directional prediction for the PU, motion estimation module 122 may search the reference pictures of list 0 or list 1 for a reference block for the PU. Motion estimation module 122 may then generate a reference index that indicates the reference picture in list 0 or list 1 that contains the reference block and a motion vector that indicates a spatial displacement between the PU and the reference block. Motion estimation module 122 may output the reference index, a prediction direction indicator, and the motion vector as the motion information of the PU. The prediction direction indicator may indicate whether the reference index indicates a reference picture in list 0 or list 1. Motion compensation module 124 may generate the predicted video block of the PU based on the reference block indicated by the motion information of the PU.

When motion estimation module 122 performs bi-directional prediction for a PU, motion estimation module 122 may search the reference pictures in list 0 for a reference block for the PU and may also search the reference pictures in list 1 for another reference block for the PU. Motion estimation module 122 may then generate reference indexes that indicate the reference pictures in list 0 and list 1 containing the reference blocks and motion vectors that indicate spatial displacements between the reference blocks and the PU. Motion estimation module 122 may output the reference indexes and the motion vectors of the PU as the motion information of the PU. Motion compensation module 124 may generate the predicted video block of the PU based on the reference blocks indicated by the motion information of the PU.

In some instances, motion estimation module 122 does not output a full set of motion information for a PU to entropy encoding module 116. Rather, motion estimation module 122 may signal the motion information of a PU with reference to the motion information of another PU. For example, motion estimation module 122 may determine that the motion information of the PU is sufficiently similar to the motion information of a neighboring PU. In this example, motion estimation module 122 may indicate, in a syntax structure associated with the PU, a value that indicates to video decoder 30 that the PU has the same motion information as the neighboring PU. In another example, motion estimation module 122 may identify, in a syntax structure associated with the PU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to determine the motion vector of the PU. By referring to the motion information of a first PU when signaling the motion information of a second PU, video encoder 20 may be able to signal the motion information of the second PU using fewer bits.

As part of performing an encoding operation on a CU, intra prediction module 126 may perform intra prediction on PUs of the CU. Intra prediction may provide spatial compression. When intra prediction module 126 performs intra prediction on a PU, intra prediction module 126 may generate prediction data for the PU based on decoded samples of other PUs in the same picture. The prediction data for the PU may include a predicted video block and various syntax elements. Intra prediction module 126 may perform intra prediction on PUs in I slices, P slices, and B slices.

To perform intra prediction on a PU, intra prediction module 126 may use multiple intra prediction mode directions or intra prediction directions to generate multiple sets of prediction data for the PU. When intra prediction module 126 uses an intra prediction direction to generate a set of prediction data for the PU, intra prediction module 126 may extend samples from video blocks of neighboring PUs across the video block of the PU in a direction and/or gradient associated with the intra prediction direction. The neighboring PUs may be above, above and to the right, above and to the left, or to the left of the PU, assuming a left-to-right, top-to-bottom encoding order for PUs, CUs, and treeblocks. Intra prediction module 126 may use various numbers of intra prediction directions (e.g., 33 intra prediction directions), depending on the size of the PU.

Prediction module 100 may select the prediction data for a PU from among the prediction data generated by motion compensation module 124 for the PU or the prediction data generated by intra prediction module 126 for the PU. In some examples, prediction module 100 selects the prediction data for the PU based on rate/distortion metrics of the sets of prediction data.

If prediction module 100 selects prediction data generated by intra prediction module 126, prediction module 100 may signal a direction of the intra prediction mode that was used to generate the prediction data for the PUs (e.g., the selected intra prediction direction). Prediction module 100 may signal the selected intra prediction direction in various ways. For example, it is probable the selected intra prediction direction is the same as the intra prediction direction of a neighboring PU. In other words, the intra prediction direction of the neighboring PU may be the most probable mode for the current PU. Thus, prediction module 100 may generate a syntax element to indicate that the selected intra prediction direction is the same as the intra prediction direction of the neighboring PU.

After prediction module 100 selects the prediction data for PUs of a CU, residual generation module 102 may generate residual data for the CU by subtracting the predicted video blocks of the PUs of the CU from the video block of the CU. The residual data of a CU may include 2D residual video blocks that correspond to different sample components of the samples in the video block of the CU. For example, the residual data may include a residual video block that corresponds to differences between luminance components of samples in the predicted video blocks of the PUs of the CU and luminance components of samples in the original video block of the CU. In addition, the residual data of the CU may include residual video blocks that correspond to the differences between chrominance components of samples in the predicted video blocks of the PUs of the CU and the chrominance components of the samples in the original video block of the CU.

Prediction module 100 may perform quadtree partitioning to partition the residual video blocks of a CU into sub-blocks. Each undivided residual video block may be associated with a different TU of the CU. The sizes and positions of the residual video blocks associated with TUs of a CU may or may not be based on the sizes and positions of video blocks associated with the PUs of the CU. A quadtree structure known as a “residual quad tree” (RQT) may include nodes associated with each of the residual video blocks. The TUs of a CU may correspond to leaf nodes of the RQT.

Transform module 104 may generate one or more transform coefficient blocks for each TU of a CU by applying one or more transforms to a residual video block associated with the TU. Each of the transform coefficient blocks may be a 2D matrix of transform coefficients. Transform module 104 may apply various transforms to the residual video block associated with a TU. For example, transform module 104 may apply a discrete cosine transform (DCT), a directional transform, or a conceptually similar transform to the residual video block associated with a TU.

After transform module 104 generates a transform coefficient block associated with a TU, quantization module 106 may quantize the transform coefficients in the transform coefficient block. Quantization module 106 may quantize a transform coefficient block associated with a TU of a CU based on a QP value associated with the CU.

Video encoder 20 may associate a QP value with a CU in various ways. For example, video encoder 20 may perform a rate-distortion analysis on a treeblock associated with the CU. In the rate-distortion analysis, video encoder 20 may generate multiple coded representations of the treeblock by performing an encoding operation multiple times on the treeblock. Video encoder 20 may associate different QP values with the CU when video encoder 20 generates different encoded representations of the treeblock. Video encoder 20 may signal that a given QP value is associated with the CU when the given QP value is associated with the CU in a coded representation of the treeblock that has a lowest bitrate and distortion metric.

Inverse quantization module 108 and inverse transform module 110 may apply inverse quantization and inverse transforms to the transform coefficient block, respectively, to reconstruct a residual video block from the transform coefficient block. Reconstruction module 112 may add the reconstructed residual video block to corresponding samples from one or more predicted video blocks generated by prediction module 100 to produce a reconstructed video block associated with a TU. By reconstructing video blocks for each TU of a CU in this way, video encoder 20 may reconstruct the video block of the CU.

After reconstruction module 112 reconstructs the video block of a CU, filter module 113 may perform a deblocking operation to reduce blocking artifacts in the video block associated with the CU. After performing the one or more deblocking operations, filter module 113 may store the reconstructed video block of the CU in decoded picture buffer 114. Motion estimation module 122 and motion compensation module 124 may use a reference picture that contains the reconstructed video block to perform inter prediction on PUs of subsequent pictures. In addition, intra prediction module 126 may use reconstructed video blocks in decoded picture buffer 114 to perform intra prediction on other PUs in the same picture as the CU.

Entropy encoding module 116 may receive data from other functional components of video encoder 20. For example, entropy encoding module 116 may receive transform coefficient blocks from quantization module 106 and may receive syntax elements from prediction module 100. When entropy encoding module 116 receives the data, entropy encoding module 116 may perform one or more entropy encoding operations to generate entropy encoded data. For example, video encoder 20 may perform a context adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding module 116 may output a bitstream that includes the entropy encoded data.

As part of performing an entropy encoding operation on data, entropy encoding module 116 may select a context model. If entropy encoding module 116 is performing a CABAC operation, the context model may indicate estimates of probabilities of particular bins having particular values. In the context of CABAC, the term “bin” is used to refer to a bit of a binarized version of a syntax element.

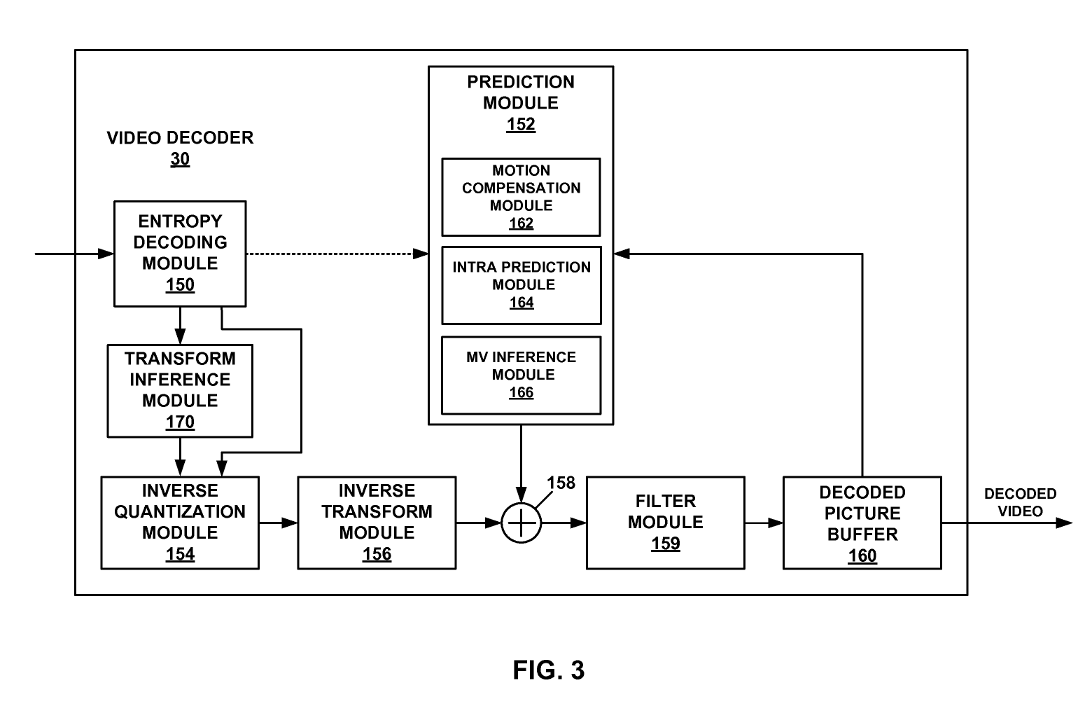

FIG. 3 is a block diagram that illustrates an example video decoder 30 that can be configured to implement the techniques of this disclosure. FIG. 3 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In accordance with embodiments of this disclosure, a video decoder 30 including a transform inference module 170 and/or a motion vector inference module 166 may be configured to code (e.g., decode) video data in a scalable video coding scheme that defines at least one base layer and at least one enhancement layer. The transform inference module 170 and motion vector inference module 166 may adaptively infer at least some syntax element values as part of a decoding process. For example, a transform size and/or a motion vector for a portion (e.g., a coding unit) an enhancement layer may be adaptively inferred from the transform size and/or motion vector in a corresponding portion of the base layer. Adaptive inference is described in greater detail below with respect to FIGS. 7-12.

In the example of FIG. 3, video decoder 30 includes a plurality of functional components. The functional components of video decoder 30 include an entropy decoding module 150, a prediction module 152, an inverse quantization module 154, an inverse transform module 156, a reconstruction module 158, a filter module 159, and a decoded picture buffer 160. Prediction module 152 includes a motion compensation module 162 and an intra prediction module 164. In some examples, video decoder 30 may perform a decoding pass generally reciprocal to the encoding pass described with respect to video encoder 20 of FIG. 2. In other examples, video decoder 30 may include more, fewer, or different functional components.

Video decoder 30 may receive a bitstream that comprises encoded video data. The bitstream may include a plurality of syntax elements. When video decoder 30 receives the bitstream, entropy decoding module 150 may perform a parsing operation on the bitstream. As a result of performing the parsing operation on the bitstream, entropy decoding module 150 may extract syntax elements from the bitstream. As part of performing the parsing operation, entropy decoding module 150 may entropy decode entropy encoded syntax elements in the bitstream. Prediction module 152, inverse quantization module 154, inverse transform module 156, reconstruction module 158, and filter module 159 may perform a reconstruction operation that generates decoded video data based on the syntax elements extracted from the bitstream.

As discussed above, the bitstream may comprise a series of NAL units. The NAL units of the bitstream may include sequence parameter set NAL units, picture parameter set NAL units, SEI NAL units, and so on. As part of performing the parsing operation on the bitstream, entropy decoding module 150 may perform parsing operations that extract and entropy decode sequence parameter sets from sequence parameter set NAL units, picture parameter sets from picture parameter set NAL units, SEI data from SEI NAL units, and so on.

In addition, the NAL units of the bitstream may include coded slice NAL units. As part of performing the parsing operation on the bitstream, entropy decoding module 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding module 150 may perform entropy decoding operations, such as CABAC decoding operations, on syntax elements in the coded slice header to recover the slice header.

As part of extracting the slice data from coded slice NAL units, entropy decoding module 150 may perform parsing operations that extract syntax elements from coded CUs in the slice data. The extracted syntax elements may include syntax elements associated with transform coefficient blocks. Entropy decoding module 150 may then perform CABAC decoding operations on some of the syntax elements.

After entropy decoding module 150 performs a parsing operation on a non-partitioned CU, video decoder 30 may perform a reconstruction operation on the non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct a residual video block associated with the CU.

As part of performing a reconstruction operation on a TU, inverse quantization module 154 may inverse quantize, i.e., de-quantize, a transform coefficient block associated with the TU. Inverse quantization module 154 may inverse quantize the transform coefficient block in a manner similar to the inverse quantization processes proposed for HEVC or defined by the H.264 decoding standard. Inverse quantization module 154 may use a quantization parameter QP calculated by video encoder 20 for a CU of the transform coefficient block to determine a degree of quantization and, likewise, a degree of inverse quantization for inverse quantization module 154 to apply.

After inverse quantization module 154 inverse quantizes a transform coefficient block, inverse transform module 156 may generate a residual video block for the TU associated with the transform coefficient block. Inverse transform module 156 may apply an inverse transform to the transform coefficient block in order to generate the residual video block for the TU. For example, inverse transform module 156 may apply an inverse DCT, an inverse integer transform, an inverse Karhunen-Loeve transform (KLT), an inverse rotational transform, an inverse directional transform, or another inverse transform to the transform coefficient block.

In some examples, inverse transform module 156 may determine an inverse transform to apply to the transform coefficient block based on signaling from video encoder 20. In such examples, inverse transform module 156 may determine the inverse transform based on a signaled transform at the root node of a quadtree for a treeblock associated with the transform coefficient block. In other examples, inverse transform module 156 may infer the inverse transform from one or more coding characteristics, such as block size, coding mode, or the like. In some examples, inverse transform module 156 may apply a cascaded inverse transform.

In some examples, motion compensation module 162 may refine the predicted video block of a PU by performing interpolation based on interpolation filters. Identifiers for interpolation filters to be used for motion compensation with sub-sample precision may be included in the syntax elements. Motion compensation module 162 may use the same interpolation filters used by video encoder 20 during generation of the predicted video block of the PU to calculate interpolated values for sub-integer samples of a reference block. Motion compensation module 162 may determine the interpolation filters used by video encoder 20 according to received syntax information and use the interpolation filters to produce the predicted video block.

If a PU is encoded using intra prediction, intra prediction module 164 may perform intra prediction to generate a predicted video block for the PU. For example, intra prediction module 164 may determine an intra prediction mode direction or intra prediction direction for the PU based on syntax elements in the bitstream. The bitstream may include syntax elements that intra prediction module 164 may use to determine the direction of the intra prediction mode of the PU.

In some instances, the syntax elements may indicate that intra prediction module 164 is to use the intra prediction direction of another PU to determine the intra prediction direction of the current PU. For example, it may be probable that the intra prediction direction of the current PU is the same as the intra prediction direction of a neighboring PU. In other words, the intra prediction direction of the neighboring PU may be the most probable mode for the current PU. Hence, in this example, the bitstream may include a small syntax element that indicates that the intra prediction direction of the PU is the same as the intra prediction direction of the neighboring PU. Intra prediction module 164 may then use the intra prediction direction to generate prediction data (e.g., predicted samples) for the PU based on the video blocks of spatially neighboring PUs.

Reconstruction module 158 may use the residual video blocks associated with TUs of a CU and the predicted video blocks of the PUs of the CU, i.e., either intra-prediction data or inter-prediction data, as applicable, to reconstruct the video block of the CU. Thus, video decoder 30 may generate a predicted video block and a residual video block based on syntax elements in the bitstream and may generate a video block based on the predicted video block and the residual video block. After reconstruction module 158 reconstructs the video block of the CU, filter module 159 may perform a deblocking operation to reduce blocking artifacts associated with the CU. After filter module 159 performs a deblocking operation to reduce blocking artifacts associated with the CU, video decoder 30 may store the video block of the CU in decoded picture buffer 160. Decoded picture buffer 160 may provide reference pictures for subsequent motion compensation, intra prediction, and presentation on a display device, such as display device 32 of FIG. 1. For instance, video decoder 30 may perform, based on the video blocks in decoded picture buffer 160, intra prediction or inter prediction operations on PUs of other CUs.

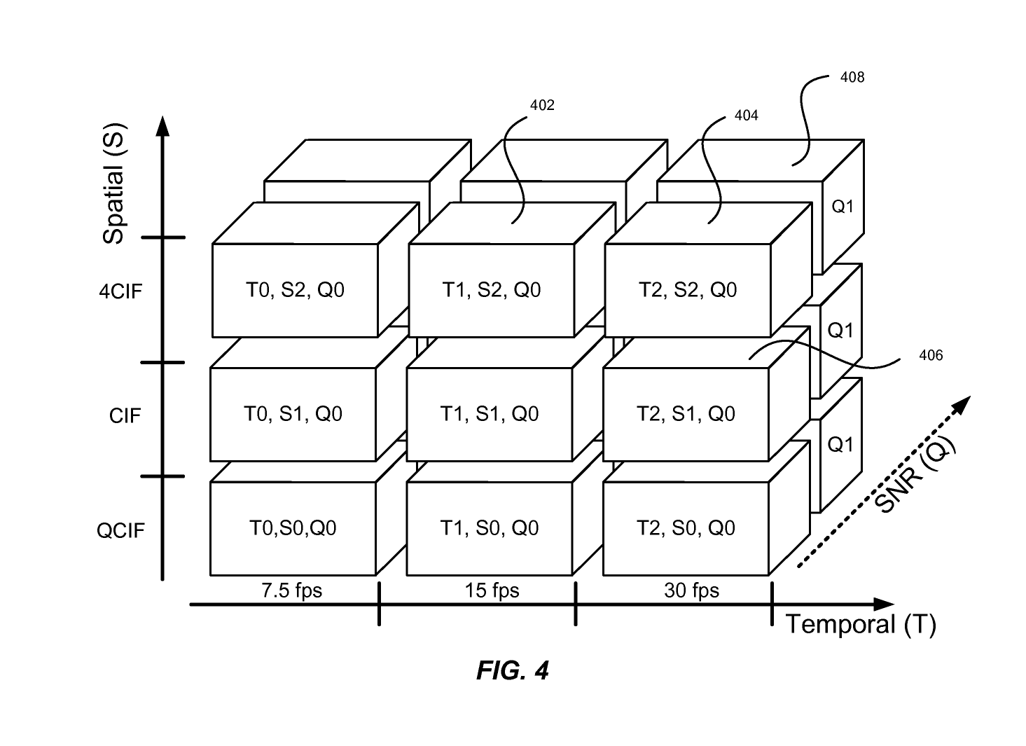

FIG. 4 is a conceptual diagram showing example scalabilities in different dimensions. The scalabilities shown are enabled in three dimensions: spatial, temporal, and signal-to-noise. In the temporal dimension illustrated in FIG. 4, frame rates with 7.5 Hz, 15 Hz or 30 Hz can be supported by temporal scalability (T). When spatial scalability (S) is supported, different video resolutions such as QCIF, CIF, 4CIF, or other resolutions may be enabled. For each specific spatial resolution and frame rate, the SNR (Q) layers can be added to improve the picture quality. SNR scalability is also referred as quality scalability. Once video content has been encoded in such a scalable way, an extractor tool may be used to adapt the actual delivered content according to application requirements, which are dependent e.g., on the clients or the transmission channel, or other device or environmental characteristics.

In the example shown in FIG. 4, each cube contains the pictures with the same frame rate (temporal layer), spatial resolution (spatial layer) and SNR (quality layer). For example, cubes 402 and 404 contain pictures with the same resolution and SNR, but different frame rates. Cubes 402 and 408 are only the same spatial layer; the have the same resolution but different frame rates and SNRs. Cubes 402 and 408 are only in the same quality layer; they have the same SNR, but different frame rates and resolutions.

Better representation can be achieved by adding those cubes (pictures) in any dimension. Combined scalability is supported when there are two, three, or even more scalabilities enabled. For example, by combining the pictures in cubes 402 with those in 404, a higher frame rate may be realized. By combining the pictures in cubes 404 with those in 408, a better SNR may be realized.

In some scalable video coding systems, the pictures with the lowest spatial and quality layer may be compatible with H.264/AVC. The pictures at the lowest temporal level form the temporal base layer, which can be enhanced with pictures at higher temporal levels. In addition to the H.264/AVC compatible layer, several spatial and/or SNR enhancement layers can be added to provide spatial and/or quality scalabilities. Each spatial or SNR enhancement layer itself may be temporally scalable, with the similar temporal scalability structure as the H.264/AVC compatible layer. For one spatial or SNR enhancement layer, the lower layer it depends on is also referred as the base layer of that specific spatial or SNR enhancement layer.

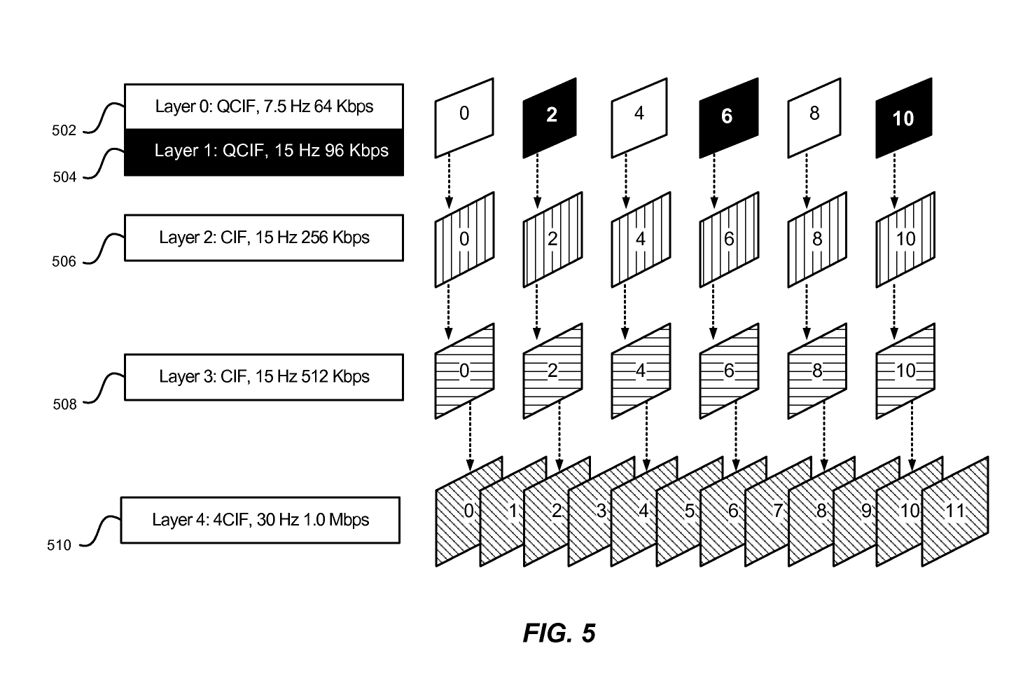

FIG. 5 is a conceptual diagram showing an example scalable video coded bitstream. In the example coding structure shown, the pictures with the lowest spatial and quality layers (pictures in base layer 502 and enhancement layer 504, which provide QCIF resolution) are compatible with H.264/AVC. Among them, those pictures of the lowest temporal level form the temporal base layer 502. This temporal base layer 502 can be enhanced with pictures of higher temporal levels, such as enhancement layer 504. In addition to the H.264/AVC compatible layer 502, several spatial and/or SNR enhancement layers can be added to provide spatial and/or quality scalabilities. For instance, enhancement layer 506 in the example can be added. Enhancement layer 506 may be a CIF representation with the same resolution. Additional enhancement layers may also be added, such as enhancement layers 508 and 510. In the example, enhancement layer 508 may be an SNR enhancement layer. As shown in the example, each enhancement layer (e.g., a spatial or SNR enhancement layer) itself may be temporally scalable, with the same temporal scalability structure as the H.264/AVC compatible layer. Also, an enhancement layer can enhance both spatial resolution and frame rate. For example, enhancement layer 510 provides a 4CIF enhancement layer, which further increases the frame rate from 15 Hz to 30 Hz.

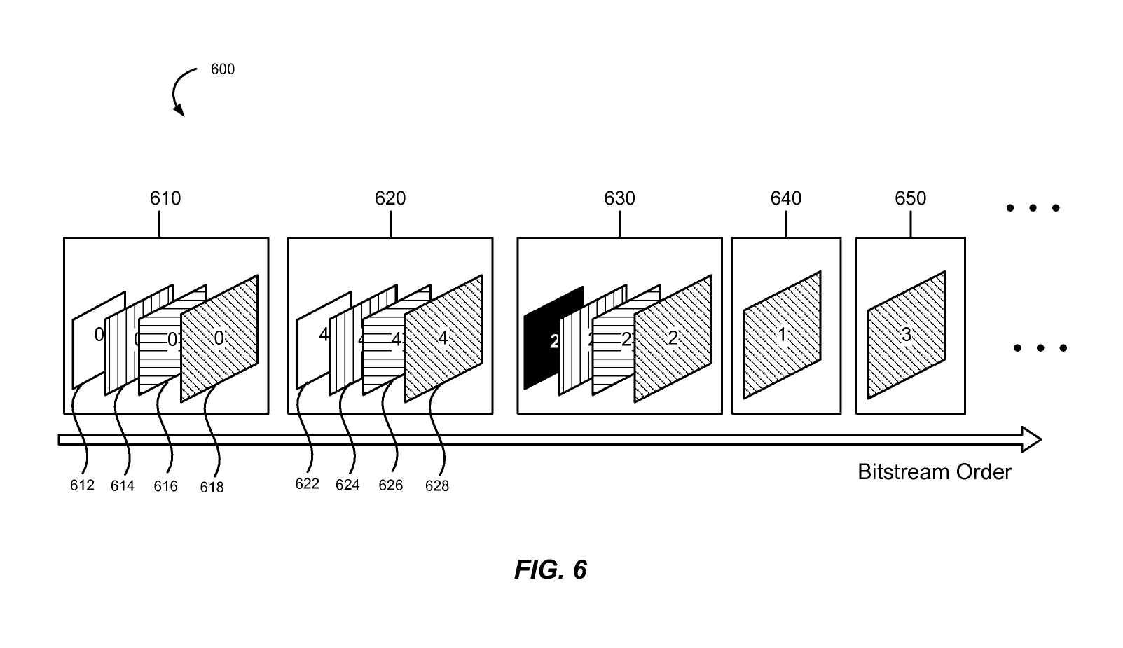

FIG. 6 is a conceptual diagram showing example access units in a scalable video coded bitstream 600. In some embodiments, as shown, the coded layers in the same time instance are successive in the bitstream order and form one access unit in the context of SVC. Those SVC access units then follow the decoding order, which could be different from the display order and decided e.g., by the temporal prediction relationship. For example, an access unit 610 consisting of all four layers 612, 614, 616, and 618 for frame 0 (e.g., for frame 0 as illustrated in FIG. 5) may be followed by an access unit 620 consisting of all four layers 622, 624, 626, 628 for frame 4 (e.g., for frame 4 in FIG. 5). An access unit 630 for frame 2 may follow out-of-order, at least from a video playback perspective. However, information from frames 0 and 4 may be used when encoding or decoding frame 2, and therefore frame 4 can be encoded or decoded prior to frame 2. Access units 640, 650 for the remaining frames between 1 and 4 may follow, as shown.

FIG. 7 is a conceptual diagram of an example reconstructed portion of a single image (e.g., a frame). The diagram includes five portions 702, 704, 706, 708, and 710. Portions 702, 704, 706, and 708 are reconstructed neighboring portions (e.g., pixels). The portion 710 is an INTRA coding unit to be predicted.

A coding unit (CU) may generally refer to a rectangular image region that serves as a basic unit to which various coding tools are applied for video compression. A CU may recursively split into smaller CUs. According to HEVC or HM (e.g., the reference software for HEVC), a CU can have one of the two prediction modes: INTRA mode and INTER mode. A prediction unit (PU) is the basic unit of prediction. An Intra CU of size 2N×2N can have two different prediction shapes: 1) a single 2N×2N PU; or 2) 4 smaller N×N PUs. A PU in the INTRA CU may be predicted spatially from already reconstructed neighboring pixels from the same frame or slice.

A prediction direction provides a reference for determining the neighboring blocks (e.g., pixels) to be used for the prediction. This may generally be referred to as intra-coding or intra-coding prediction. Multiple intra prediction directions may be provided. For example, an optimal direction may be identified through a signal in the bitstream. The directions may be specified at different levels within the video data. For example, different PUs in an INTRA CU may have different prediction directions.

A PU in the INTER CU is predicted temporally based at least in part on best matched block and/or weighted blocks in already decoded previous frame or frames (in decoded order). Such blocks may be referred to as reference blocks. Different PUs in an INTER CU may have different motion information (e.g., motion vectors). The motion vector which identifies the reference block or blocks may be signaled in the bitstream.

In some embodiments, the motion vector for an enhancement layer PU or CU may be inferred from a corresponding PU or CU in a base layer. For example, portion 710 may be a portion of an enhancement layer. A co-located portion of a base layer may be associated with a particular motion vector. When a coder is coding video using an adaptive inference mode, the motion vector from the enhancement layer portion may be determined based on the motion vector from a corresponding portion 710 of the base layer. The motion vector may be scaled or otherwise modified for use in the enhancement layer. The same or a similar technique may be used to adaptively infer other syntax element values, such as the transform size. Scaling and other modifications used in adaptive inference are described in greater detail below with respect to FIGS. 10-12.

FIG. 8 is a conceptual diagram of two example portions of video data: a first frame 802 and a second frame 804. The first frame 802 includes a reference block 806 and a motion vector 808 associated with the reference block. The motion vector 808 may identify how the reference block 806 moves from the first frame 802 to the second frame 804. Using the motion vector 808 and the reference block 806, the location of the reference block 806 may be determined in the second frame 804. This may generally be referred to as inter-coding or inter-coding prediction. It should be noted that the location identified by the motion vector 808 is spatially collocated with the location of the reference block 806 in the second frame 804. As briefly mentioned above and described in greater detail below, such motion vectors may be adaptively inferred for enhancement layer blocks from corresponding portions of base layer blocks.

In addition to inferring motion vectors, or alternatively, other syntax element values may be inferred in an adaptive inference coding mode. For example, a transform size for an enhancement layer block may be adaptively inferred from a corresponding base layer block. A transform unit (TU) is the unit of video information to which a single transform is applied. The transform is applied, and the transformed values (e.g., the transform coefficients) are signaled in a quad-tree structure which may be referred to as a residual quad-tree (RQT). Different transforms may be applied to different TUs within the same bitstream, frame, layer, etc. For example, the size of the TU affects the application of a transform to values in the unit. Conventionally, the size of the transform can be encoded into a bitstream that is transmitted to a decoder (along with transform coefficients and other video information), and the decoder can extract the transform size in order to properly transform to the coefficients. In adaptive inference mode, however, the size of a TU need not always be transmitted for enhancement layer blocks. Instead, the TU size may be inferred from a corresponding block or blocks of the base layer. In addition, the TU size for a given enhancement layer block may be calculated as a function of the TU size for corresponding base layer block, as described in greater detail below.

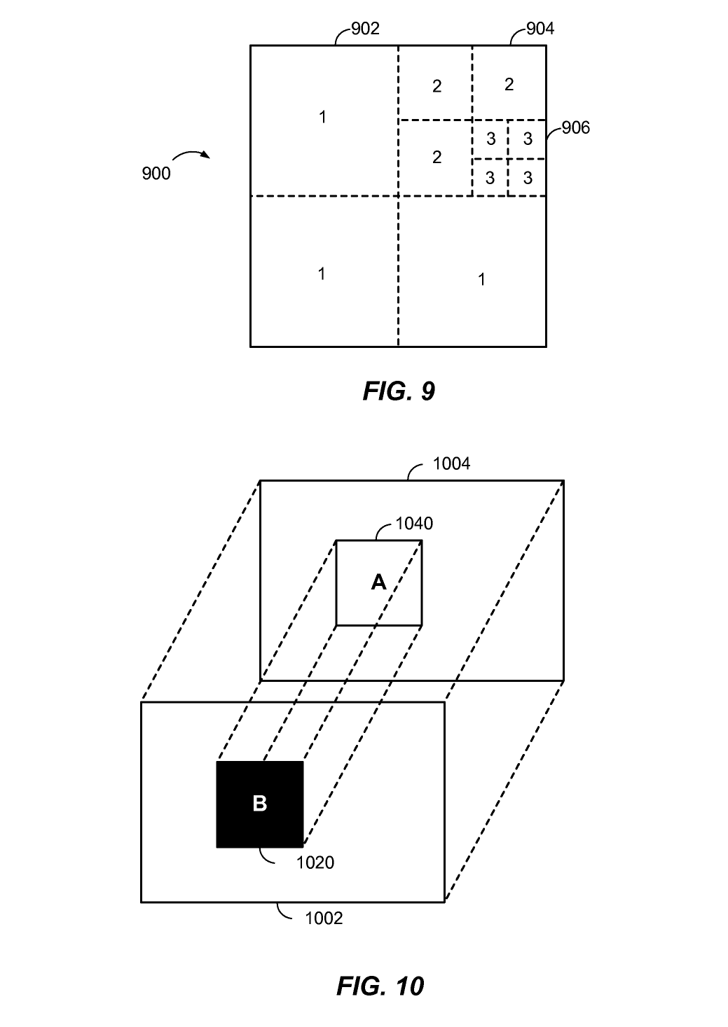

FIG. 9 is a conceptual diagram of an example coding unit. The original coding unit 900 is shown with solid lines. The dashed lines indicate one outcome of transform block decomposition according to a quad-tree structure. Such an outcome is just one out of many possible decomposition operations. In the example shown in FIG. 9, there are three levels of transform decomposition. With level-1 (depth1) decomposition, the whole block 900 is split into four quarter-sized blocks, labeled “1” in the illustration. Block 902 is one example of a quarter-sized block. At level-2 (depth2), a quarter-sized transform block is further split into four 1/16 sized transform blocks, labeled “2” in the illustration. Block 904 is an example of a 1/16 sized block. At level-3 (depth3), a 1/16 sized transform block is further split into four even smaller transform blocks. Block 906 is an example of a 1/64 sized block. In practice, whether a transform block is to be split further may be determined based on various factors, such as rate-distortion optimization. The split/not split decision can be signaled at each level using a flag (e.g., transform split flag), or it may be adaptively inferred from a corresponding base layer block.

FIG. 10 is a conceptual diagram of an example frame or other portion of video data including layers encoded based on inheriting or inferring syntax elements from a base layer. As discussed above, for scalable video coding, there is one absolute base layer (layer 0) and any number of enhancement layers (layers 1, 2, 3 . . . ). Each enhancement layer may serve as a base layer for other layers above it. When coding layer i, lower layers (0, . . . , i−1) have already been coded and all info from lower layers may be available and used to code layer i. A new mode which may be referred to as “inference mode” can be introduced in the coding of enhancement layer information.

The diagram in FIG. 10 includes a base layer 1002 and an enhancement layer 1004. For a block 1040 in the enhancement layer 1004 being encoded in inference mode, a corresponding region 1020 in the base layer 1002 can be found. In some embodiments, the block 1040 in the enhancement layer 1004 can inherit all or part of syntax element values of the corresponding region 1020 in the base layer 1002. For example, the enhancement layer block 1040 can inherit the motion information (e.g., motion vector) of the block 1020 in the base layer 1002, or the enhancement layer block 1040 can inherit the transform structure (e.g., transform depth/transform size) of the block 1020 in the base layer 1002.

In the inference mode, however, because the enhancement layer 1004 and the base layer 1002 may be encoded using different conditions, simply inheriting or copying the syntax element value from the corresponding region 1020 of the base layer 1002 may not be the best strategy for enhancement layer 1004 coding of the enhancement layer block 1040. On a destination device, this same principle may apply to decoding the enhancement layer block 1040. Accordingly, an “adaptive inference mode” may be provided to allow a more efficient mechanism for specifying this video information.

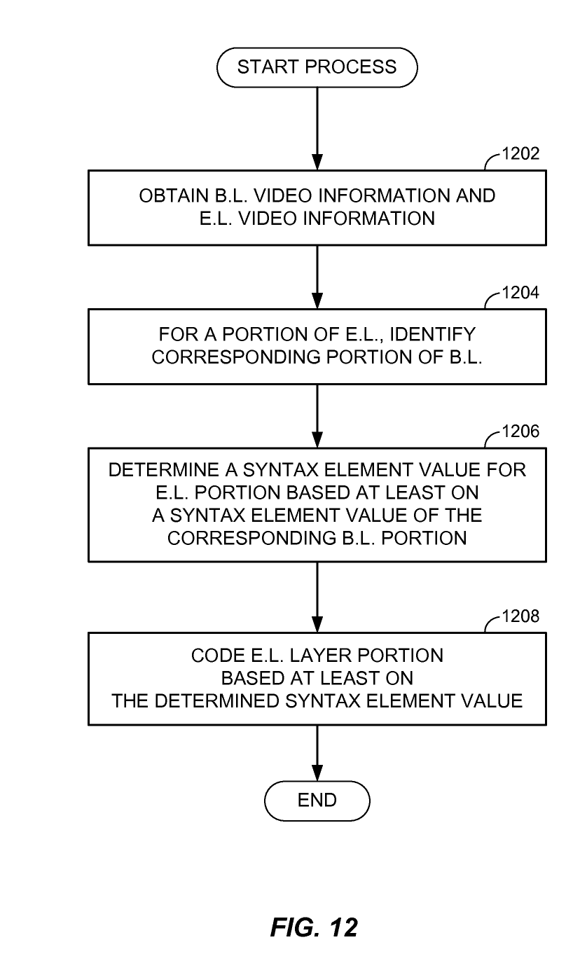

As used herein, the term “infer,” in the context of syntax element values, refers to determining an enhancement layer syntax element value based at least on a base layer syntax element. The determination may include copying or inheriting the syntax element value, or a base layer syntax element value may be used as one factor among several in computing, calculating, or otherwise determining the enhancement layer syntax value. One example process for implementing an adaptive inference mode is described in greater detail below with respect to FIG. 12.

In adaptive inference mode, the syntax element values of the enhancement layer 1004 may be inferred from the corresponding syntax element values of the base layer 1002. For example, let A be a coding unit at the enhancement layer 1004, such as block 1040. Let B be a region in the base layer 1002 that corresponds to coding unit A in the enhancement layer 1004, such as block 1020. B can be the collocated block in the base layer, (e.g., B has the same spatial coordinates as A, such as blocks 1020 and 1040 in FIG. 10, where block 1040 is an enhancement layer block and block 1020 is a collocated base layer block), or B can be a block spatially offset relative to A, or in a scaled location with respect to A. When the enhancement layer image is a scaled version of the base layer image, B may have a different size from A and the size ratio between A and B may be the same as the size ratio between enhancement layer image and base layer image.

Coding unit A may encompass multiple basic units, and each such unit may have its own syntax element(s). In HEVC, the basic unit (smallest unit) of intra prediction direction is a 4×4 unit. The syntax element values in unit A can be inferred from the syntax element values in unit B. For example, for every 4×4 unit in unit A, a corresponding location in coding unit B can be found, and the motion vector in that corresponding location may be used as the motion vector for the 4×4 unit in A. This process may be performed at both the encoder and the decoder, so the motion vectors in the unit A do not need to be encoded and transmitted. In addition to motion vectors, the inference can also be applied to other syntax elements, such as motion vector reference frame index, inter prediction direction, intra prediction direction, inter/intra prediction mode, transform size/transform depth of RQT tree, and the like. In some embodiments, each of these and other syntax elements may be inferred from base layer syntax elements. In additional embodiments, only a subset of syntax elements may be inferred from a base layer syntax element.

In some embodiments, the inference of one or more syntax elements according to the techniques described herein may be conditional, based on environmental characteristics (e.g., characteristics of the encoder or decoder, characteristics of the available network connection) or characteristics of the video. For example, in scalable video coding, a CU can be encoded in different modes. One mode may include inferring a value for one particular syntax element, while another mode may include inferring a value for a different syntax element. There may also be one or more modes that include inference of values for multiple syntax elements, and/or a mode that does not use inference of syntax element values at all. The encoder can perform multiple passes using different modes, and then choose which mode to use for coding the bitstream for any particular CU based on rate-distortion criterion (i.e., the one gives the lowest rate and the highest fidelity), the best performance, etc.

In some embodiments, it may be desirable to selectively use inference mode or adaptive inference mode. For example, in some cases, inference mode may not provide satisfactory results. The inference coding described herein can be signaled using a separate flag, such as “Inference FLAG.” The signaling can be done at various levels, such as the PU level, CU level, or the slice level of the video. When a decoder detects the Inference FLAG, it can proceed to infer one or more syntax elements from a base layer. When other flags are signaled, inference mode will not be activated. The signaling can also be done using an extra mode number. For example, existing modes for HEVC include SIZE 2N×2N, and SIZE 2N×N, corresponding to values 0, 1, and 2, respectively. A fourth mode may be added, such as SIZE INFER, which may correspond to a value of 3.

In some embodiments, rather than directly copying a base layer syntax value, a syntax element in enhancement layer can be generated based on the corresponding syntax element value at the base layer. For example, an enhancement layer may have a frame size of 2M×2N, while the base layer has a frame size of M×N. Thus, for a 4×4 unit in the base layer (e.g., unit B), its motion vector (MVB) would not be directly inferable to the corresponding unit in the enhancement layer (e.g., unit A). Instead, the motion vector for unit A (MVA) can be a scaled version of the corresponding motion vector (MVB) at base layer unit B. The scaling factor can be related to the frame size ratio. Equation (1) shows one possible expression of this relationship.

MVA=2*MVB (1)

In another example, the transform size for a block in the enhancement layer (TrA) may be generated based on the transform size of a corresponding block at the base layer (TrB). Equation (2) shows one possible expression for generating the transform size for the enhancement layer.

TrA=a*TrB+b (2)

The values of a and b can be transmitted using high level syntax, or they can be derived from information available to the coder. For example, the values may be derived from quantization parameter(s) of base layer coding and/or of enhancement layer coding. In some embodiments, other values may be used for a, b, or any other coefficient in a function used to adaptively infer a syntax element value. For example, values may be based at least partly on frame size of base layer, frame size of enhancement layer, frame rate of base layer, frame rate of enhancement layer, maximum/minimum transform size of enhancement layer, maximum/minimum transform size of base layer, maximum/minimum CU size of enhancement layer, maximum/minimum CU size of base layer, and/or the like.

Equations (1) or (2) may be applied to other syntax elements in order to infer a syntax element for an enhancement layer. The examples used above are illustrative only, and are not meant to be limiting. In some embodiments, other equations may be used. An example process for coding video, in which equations (1), (2), or other such adaptations may be used, is described in detail below with respect to FIG. 12.

In some implementations, a merge or fusion of syntax elements from multiple base layer blocks may be performed to infer enhancement layer syntax elements, such as when a unit in an enhancement layer covers multiple units in a base layer. In this case, the syntax element value at the enhancement layer can be a function of syntax element values of the multiple units at the base layer. The function can be user-defined and signaled using high level syntax, or can be pre-defined at both the encoder and the decoder. It can be adaptive for different syntax elements.

For example, suppose an 8×8 unit at an enhancement layer covers four 4×4 units at a base layer. A merge may be used to derive a single intra prediction direction from the 4 intra prediction directions from the base layer. According to one method, an intra prediction direction for the 8×8 unit at the enhancement layer can be calculated or otherwise determined as that which has the minimum angular difference compared to the four 4×4 intra prediction directions of the base layer units. Other methods may involve the use of some pre-defined direction, like Planar or DC mode.

In another example, suppose a 16×16 unit at an enhancement layer covers sixteen 4×4 units at a base layer. A merge may be used to derive a single motion vector from the sixteen 4×4 base layer units. The derived value can be the median value of the motion vectors of the sixteen 4×4 base layer units, the mean value of the motion vectors of the sixteen 4×4 base layer units, etc. Alternatively the derived value for the 16×16 unit at the enhancement layer can be the median or the mean value of the motion vectors of the 16 units that point to a particular reference frame.

In some embodiments, the basic unit size of the enhancement layer can be adaptively determined. For example, the basic unit size of a motion vector of an enhancement layer can be 8×8 for luma and 4×4 for chroma. The basic unit size of a transform at the enhancement layer can be 8×8. For each of these basic units, a corresponding location at the base layer may be found, and a syntax element value at that location can be used for the basic unit at the enhancement layer. The adaptive basic unit size can be pre-defined at both the encoder and the decoder, or can be user-selected and transmitted to the decoder. A single implementation need not offer both of these features. For example, some embodiments may implement only pre-defined basic unit sizes, while other may implement only user-selectable unit sizes.

The basic unit size can be dependent on other information available to the coder, including, but not limited to, the syntax element whose value is being inferred, frame size, frame type, prediction mode, inter-prediction direction, intra prediction mode, coding unit size, maximum/minimum coding unit size, maximum/minimum transform unit size, maximum transform tree depth reference frame index, temporal layer id, etc. Some embodiments may determine basic unit size based on only a subset of these options. One non-limiting advantage of using an adaptive basic unit size can be memory bandwidth reduction and/or complexity reduction.

In some embodiments, weights, weighting indices and the like, such as those associated with weighting prior frames and base layer frames when using certain prediction techniques, may be inferred in an adaptive inference mode.

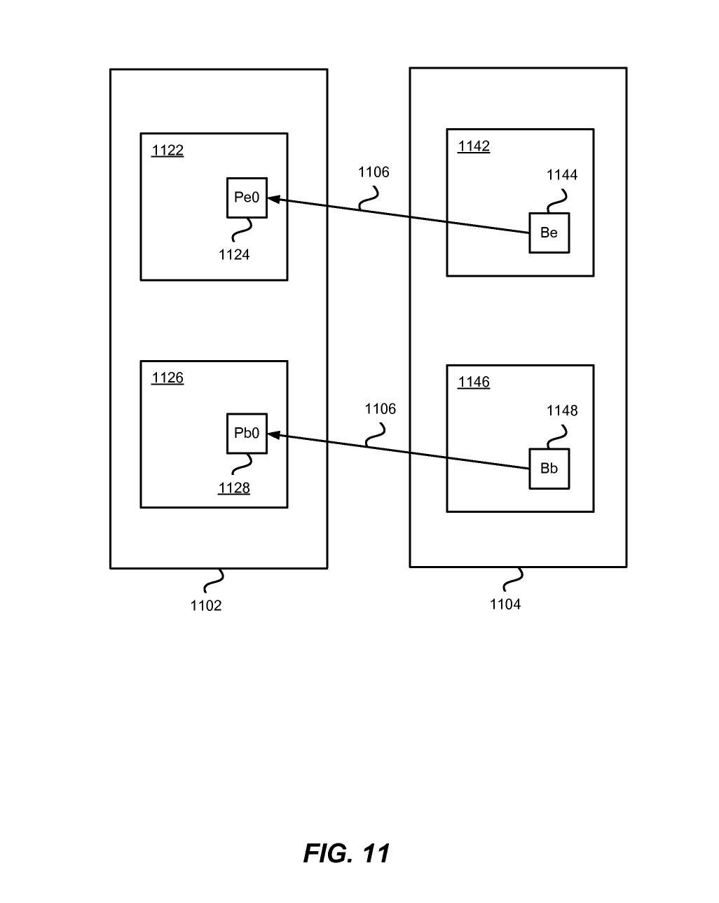

FIG. 11 shows the use of inter-predicted residues of co-located base layer blocks to predict the residues of an enhancement layer block. Illustratively, this method may be applied to inter CUs and skip mode CUs. Residual prediction of this kind may be used for scalable video coding and 3D video coding.

In FIG. 11, block 1144 (Be) and block 1148 (Bb) denote the current block in the enhancement layer picture 1142 and its co-located base layer block in the base layer picture 1146, respectively. Block 1124 (Pe0) denotes the temporal prediction for block 1144 obtained by using motion vector 1106. Similarly, block 1128 (Pb0) represents the temporal prediction for block 1148, obtained by using the same motion vector 1106 in the up-sampled (if necessary) base layer reference picture 1126. The inter predicted residue of the base layer block, denoted Rb0, may be obtained as the difference between blocks 1148 and 1128 (e.g., Bb−Pb0).

Considering the temporal prediction 1124 for block, 1144, the final uni-prediction, denoted P, for block 1144 may be obtained as follows:

P=Pₑ₀+w·(B_{b}−P_{b0})=(Pₑ₀−w·P_{b0})+wB_{b} (3)

(where w is a weighting factor, which takes the value 0, 0.5, or 1).

In some cases, the following variant may sometimes be more efficient

P=B_{b}+w·(Pₑ₀−P_{b0}) (4)

(where w=0.5).

Therefore, four weighting modes (e.g., w=0, 0.5, or 1 in equation (3), or w=0.5 in equation (4)), may be used in this residual prediction technique. In some embodiments, the weighting factor w may be signaled at the CU level as a weighting index. (e.g., weighting indices 0, 1, 2 and 3 may be used to indicate the weighting modes w=0, 0.5 or 1 in equation (3) and w=0.5 in equation (4), respectively). Examples of residual prediction techniques are discussed further in further detail in U.S. Provisional Patent Application Nos. 61/670,075 filed Jul. 10, 2012 (Attorney Docket 123321P1); 61/706,692 filed Sep. 27, 2012 (Attorney Docket 123321P2); 61/680,522 filed Aug. 7, 2012 (Attorney Docket 123654P1); 61/731,448 filed August Nov. 29, 2012 (Attorney Docket 130726P1) and 61/747,028 filed Dec. 28, 2012 (Attorney Docket 131079P1). Each of the aforementioned applications is hereby incorporated by reference in its entirety.

In some embodiments, a weighting index is additionally signaled for inferred mode. Alternatively, a certain weighting mode may be coupled with inferred mode. For example, weighting mode 2 (weighting factor 1) may be specified for inferred mode. As another example, when inferred mode is used, a residual weighting index of 2 is automatically enabled and no weighting index is signaled. An indication of which weighting mode is coupled with inferred mode may be signaled at any level of bitstream, such as SPS, PPS, and slice header. Similarly, a weighting index may also optionally be combined and/or coupled with any CU/PU coding mode which uses derived motion information.

Turning now to FIG. 12, a process flow diagram for an exemplary method of coding video is shown. The process shown in FIG. 12 may be used to encode video data, or to decode video data. When used to encode video data, the process may be implemented in one or more of the devices described herein, such as, for example, a destination device 16 or a video decoder 30. When used to decode video data, the process may be implemented in one or more of the devices described herein, such as, for example, the source device 12 or a video encoder 20.

The process flow begins at block 1202, where a base layer and an enhancement layer of video information are obtained. In some embodiments, the video information is received from a network link, disk, or some other computer-readable medium. When the process is used by an inference module 130 of an encoder 20 to encode video, the video may be loaded from, or provided, by some module or component of the encoder 20. When the process is used by an inference module 170 of a decoder 30 to decode data, the video may be loaded from, or provided by, some module or component of the decoder 30. In some embodiments, the layers may be received as digital signals through wired and/or wireless means (e.g., USB, PSTN, Ethernet, cellular, satellite, WiFi, Bluetooth, etc.). The layers may be received separately or as part of the same transmission. In some embodiments, the layers may be received directly from the source device 12. In some embodiments, the layers may be received from the source device 12 via one or more intermediaries. Layers or portions thereof may also be received from multiple source devices. The receiving process may also include storing the received layers in memory.

At block 1204, a device executing the process may identify, for a portion of enhancement layer video information, one or more corresponding portions of base layer video information. The portions of either the enhancement layer or the base layer may be PUs, CUs, TUs, slices, or the like. As described above, the one or more portions of base layer video may be collocated with the portion of enhancement layer video, or offset from the enhancement layer video by some predetermined or dynamically determined coordinates. For example, an enhancement layer picture may have size of 1920×1080 pixels. The base layer picture may be a cropped version of the picture, such as a picture with a size of 960×540 pixels (x from 100-1060, and y from 100-640). The portion of the base layer that corresponds to any particular portion of the enhancement layer may have a spatial offset with respect to the enhancement layer.

At block 1206, a syntax element value for the portion of enhancement layer video information is determined based at least on a syntax element value for the corresponding portion or portions of base layer video information (e.g., the portion identified above at block 1204). In some embodiments, the syntax element value that is being inferred or otherwise determined for the enhancement layer may be a motion vector or a transform size. As described in greater detail above with respect to FIG. 10, these values may be scaled from syntax element values of corresponding base layer portions, or they may be a function of syntax element values of corresponding base portions (e.g., using equations (2) or (3)). In some embodiments, the respective syntax element values may include one or more of prediction direction, motion vector reference index, prediction mode, residual quad-tree transform size, residual quad-tree transform depth, quantization parameter of the first layer, quantization parameter of the second layer, frame size of the first layer, frame size of the second layer, transform size of the first layer, transform size of the second layer, coding unit size for the first layer, and coding unit size for the second layer.

At block 1208, the device or component executing the process can code the current enhancement layer portion based at least on the syntax element value determined in block 1206, above. For example, an encoder 20 may encode the current portion of the enhancement layer based on the syntax element value determined above. As another example, a decoder 30 may decode the current portion of the enhancement layer based at least on the syntax element value determined above.

The process shown in FIG. 12 and described above, or some variant thereof, may be repeated for each portion of each enhancement layer, or some portion thereof. For example, when coding a particular enhancement layer frame, 1204, 1206, and 1208 may be repeated for each portion of the enhancement layer frame.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Similarly, the signals described above include one or more fields which may be used in various implementations. The signals may include additional fields, fewer fields, and/or alternative field arrangements without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an encoding device and/or decoding device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for coding digital video, the apparatus comprising:
a memory configured to store base layer video information and enhancement layer video information, wherein the base layer video information comprises one or more base layer syntax element values for each of one or more portions of the base layer; and
a processor configured to determine an enhancement layer syntax element value for a portion of the enhancement layer based at least on a base layer syntax element value of the one or more base layer syntax element values for a corresponding portion of the one or more portions of the base layer, wherein the enhancement layer syntax element value corresponds to one of a motion vector or a transform size.

2. The apparatus of claim 1, wherein the base layer syntax element value comprises a value for one or more of: prediction direction, motion vector, reference index, prediction mode, residual quad-tree transform size, residual quad-tree transform depth, quantization parameter of the base layer, quantization parameter of the enhancement layer, frame size of the base layer, frame size of the enhancement layer, transform size of the base layer, transform size of the enhancement layer, coding unit size for the base layer, or coding unit size for the enhancement layer.

3. The apparatus of claim 1, wherein the corresponding portion of the base layer comprises one of: a prediction unit collocated with the portion of the enhancement layer, a coding unit collocated with the portion of the enhancement layer, prediction unit offset from the portion of the enhancement layer, or a coding unit offset from the portion of the enhancement layer.

4. The apparatus of claim 1, wherein the processor is configured to determine, based at least on the enhancement layer of video information, whether to determine the enhancement layer syntax element value based at least on the base layer syntax element value.

5. The apparatus of claim 1, wherein the processor is configured to determine the enhancement layer syntax element value for the portion of the enhancement layer as a function of the base layer syntax element value for the corresponding portion of the base layer.

6. The apparatus of claim 5, wherein the function comprises a linear relationship between the base layer syntax element value and the enhancement layer syntax element value, and wherein a parameter of the function is based at least on an element of video information for the base layer or the enhancement layer.

7. The apparatus of claim 5, wherein the function is based at least on a spatial scaling ratio of frame sizes associated with the base layer and the enhancement layer.

8. The apparatus of claim 1, wherein the processor is configured to determine an enhancement layer motion vector for the portion of the enhancement layer based at least on a base layer motion vector for the corresponding portion of the base layer and one or more additional motion vectors for one or more additional corresponding portions of the base layer.

9. The apparatus of claim 8, wherein the function comprises calculating a mean or a median of the base layer motion vector and the at least one of the one or more additional motion vectors.

10. The apparatus of claim 1, wherein the processor is further configured to determine an enhancement layer basic unit size for the portion of the enhancement layer based at least on a base layer basic unit size for the corresponding portion of the base layer.

11. The apparatus of claim 1, wherein the processor is further configured to determine a past frame weight and a base layer weight based at least on determination of whether to code in an inference mode.

12. The apparatus of claim 1, wherein the processor is further configured to process a syntax element value extracted from an encoded bitstream.

13. The apparatus of claim 1, wherein the processor is further configured to encode a syntax element value in a bitstream.

14. The apparatus of claim 1, wherein the apparatus is part of a device, the device selected from the group consisting of a desktop computer, a notebook computer, a tablet computer, a set-top box, a telephone handset, a television, a camera, a display device, a digital media player, a video gaming console, and a video streaming device.

15. A method of decoding video, the method comprising:
obtaining a video bitstream defining base layer video information and enhancement layer video information, wherein the base layer video information comprises one or more base layer syntax element values for each of one or more portions of the base layer; and
determining an enhancement layer syntax element value for a portion of the enhancement layer based at least on a base layer syntax element value of the one or more base layer syntax element values for a corresponding portion of the one or more portions of the base layer, wherein the enhancement layer syntax element value corresponds to one of a motion vector or a transform size.

16. The method of claim 15, wherein the base layer syntax element value comprises a value for one or more of: prediction direction, motion vector, reference index, prediction mode, residual quad-tree transform size, residual quad-tree transform depth, quantization parameter of the base layer, quantization parameter of the enhancement layer, frame size of the base layer, frame size of the enhancement layer, transform size of the base layer, transform size of the enhancement layer, coding unit size for the base layer, or coding unit size for the enhancement layer.

17. The method of claim 15, wherein the corresponding portion of the base layer comprises one of: a prediction unit collocated with the portion of the enhancement layer, a coding unit collocated with the portion of the enhancement layer, prediction unit offset from the portion of the enhancement layer, or a coding unit offset from the portion of the enhancement layer.

18. The method of claim 15, further comprising determining, based at least on the enhancement layer of video information, whether to determine the enhancement layer syntax element value based at least on the base layer syntax element value.

19. The method of claim 15, further comprising determining the enhancement layer syntax element value for the portion of the enhancement layer as a function of the base layer syntax element value for the corresponding portion of the base layer.

20. The method of claim 19, wherein the function comprises a linear relationship between the base layer syntax element value and the enhancement layer syntax element value, and wherein a parameter of the function is based at least on an element of video information for the base layer or the enhancement layer.

21. The method of claim 19, wherein the function is based at least on a spatial scaling ratio of frame sizes associated with the base layer and the enhancement layer.

22. The method of claim 15, further comprising determining an enhancement layer motion vector for the portion of the enhancement layer based at least on a base layer motion vector for the corresponding portion of the base layer and one or more additional motion vectors for one or more additional corresponding portions of the base layer.

23. The method of claim 22, wherein the function comprises calculating a mean or a median of the base layer motion vector and the at least one of the one or more additional motion vectors.

24. The method of claim 15, further comprising determining an enhancement layer basic unit size for the portion of the enhancement layer based at least on a base layer basic unit size for the corresponding portion of the base layer.

25. The method of claim 15, further comprising determining a past frame weight and a base layer weight based at least on determination of whether to decode in an inference mode.

26. A method of encoding video, the method comprising:
generating a video bitstream defining base layer video information and enhancement layer video information, wherein the base layer video information comprises one or more base layer syntax element values for each of one or more portions of the base layer; and
determining an enhancement layer syntax element value for a portion of the enhancement layer based at least on a base layer syntax element value of the one or more base layer syntax element values for a corresponding portion of the one or more portions of the base layer, wherein the enhancement layer syntax element value corresponds to one of a motion vector or a transform size.

27. The method of claim 26, wherein the base layer syntax element value comprises a value for one or more of: prediction direction, motion vector, reference index, prediction mode, residual quad-tree transform size, residual quad-tree transform depth, quantization parameter of the base layer, quantization parameter of the enhancement layer, frame size of the base layer, frame size of the enhancement layer, transform size of the base layer, transform size of the enhancement layer, coding unit size for the base layer, or coding unit size for the enhancement layer.

28. The method of claim 26, wherein the corresponding portion of the base layer comprises one of: a prediction unit collocated with the portion of the enhancement layer, a coding unit collocated with the portion of the enhancement layer, prediction unit offset from the portion of the enhancement layer, or a coding unit offset from the portion of the enhancement layer.

29. The method of claim 26, further comprising determining, based at least on the enhancement layer of video information, whether to determine the enhancement layer syntax element value based at least on the base layer syntax element value.

30. The method of claim 26, further comprising determining the enhancement layer syntax element value for the portion of the enhancement layer as a function of the base layer syntax element value for the corresponding portion of the base layer.

31. The method of claim 30, wherein the function comprises a linear relationship between the base layer syntax element value and the enhancement layer syntax element value, and wherein a parameter of the function is based at least on an element of video information for the base layer or the enhancement layer.

32. The method of claim 30, wherein the function is based at least on a spatial scaling ratio of frame sizes associated with the base layer and the enhancement layer.

33. The method of claim 26, further comprising determining an enhancement layer motion vector for the portion of the enhancement layer based at least one a base layer syntax motion vector for the corresponding portion of the base layer and one or more additional motion vectors for one or more additional corresponding portions of the base layer.

34. The method of claim 33, wherein the function comprises calculating a mean or a median of the base layer motion vector and the at least one of the one or more additional motion vectors.

35. The method of claim 26, further comprising determining an enhancement layer basic unit size for the portion of the enhancement layer based at least on a base layer basic unit size for the corresponding portion of the base layer.

36. The method of claim 26, further comprising determining a past frame weight and a base layer weight based at least on determination of whether to encode in an inference mode.

37. A computer readable storage medium comprising instructions executable by a processor of an apparatus, the instructions causing the apparatus to:
obtain base layer video information and enhancement layer video information, wherein the base layer video information comprises one or more base layer syntax element values for each of one or more portions of the base layer; and
determine an enhancement layer syntax element value for a portion of the enhancement layer based at least on a base layer syntax element value of the one or more base layer syntax element values for a corresponding portion of the one or more portions of the base layer, wherein the enhancement layer syntax element value corresponds to one of a motion vector or a transform size.

38. The computer readable storage medium of claim 37, the instructions further causing the apparatus to determine the enhancement layer syntax element value for the portion of the enhancement layer as a function of the base layer syntax element value for the corresponding portion of the base layer.

39. An apparatus for coding digital video, the apparatus comprising:
means for obtaining base layer video information and enhancement layer video information, wherein the base layer video information comprises one or more base layer syntax element values for each of one or more portions of the base layer; and
means for determining an enhancement layer syntax element value for a portion of the enhancement layer based at least on a base layer syntax element value of the one or more base layer syntax element values for a corresponding portion of the one or more portions of the base layer, wherein the enhancement layer syntax element value corresponds to one of a motion vector or a transform size.

40. The apparatus of claim 39 further comprising means for determining the enhancement layer syntax element value for the portion of the enhancement layer as a function of the base layer syntax element value for the corresponding portion of the base layer.
